(19) United States
(12) Patent Application Publication
(10) Pub. No.: US 2013/0194213 A1
(43) Pub. Date: Aug. 1, 2013

(54) TOUCH-SENSING PANEL AND TOUCH-SENSING DISPLAY APPARATUS

(71) Applicants: Jen-Yen Chou, Taichung City (TW); Cheng-Yen Yeh, Taichung City (TW); Jiann-Liang Chou, New Taipei City (TW); Chung-Kai Lin, Taichung City (TW); Chih-Jung Teng, Taichung City (TW); Chen-Hao Su, Taichung City (TW)

(72) Inventors: Jen-Yen Chou, Taichung City (TW); Cheng-Yen Yeh, Taichung City (TW); Jiann-Liang Chou, New Taipei City (TW); Chung-Kai Lin, Taichung City (TW); Chih-Jung Teng, Taichung City (TW); Chen-Hao Su, Taichung City (TW)

(73) Assignees: WINTEK CORPORATION, Taichung City (TW); Dongguan Masstop Liquid Crystal Display Co., Ltd., Guangdong Province (CN)

(21) Appl. No.: 13/746,309

(22) Filed: Jan. 22, 2013

(30) Foreign Application Priority Data
Jan. 31, 2012 (TW) 101103070

(51) Int. Cl. G06F 3/041

(52) U.S. Cl. CPC G06F 3/041
USPC 345/173

(57) ABSTRACT

A touch-sensing panel including a substrate, a plurality of first electrode series, a plurality of second electrode series, and a plurality of first floating patterns is provided. Each of the first electrode series includes a plurality of first touch-sensing pads and a plurality of first bridge patterns. The second electrode series are disposed on the substrate and electrically insulated from each other. The second sensing series are intersected with and electrically insulated from the first sensing series. Each of the second electrode series includes a plurality of second touch-sensing pads and a plurality of second bridge patterns. The first floating patterns are disposed between the first sensing series and the second sensing series. Each of the first touch-sensing pads includes at least one extending portion. In addition, there is no first floating pattern located between the extending portion and the second electrode series adjacent thereto.

### CROSS-REFERENCE TO RELATED APPLICATION

This application claims the priority benefit of Taiwan application serial no. 101103070, filed on Jan. 31, 2012. The entirety of the above-mentioned patent application is hereby incorporated by reference herein and made a part of this specification.

### BACKGROUND OF THE INVENTION

1. Technical Field

The present invention relates generally to a electronic device, and more particularly, to a touch-sensing display and a touch-sensing display apparatus.

2. Description of Related Art

A conventional capacitive touch-sensing panel includes a plurality of first sensing series electrically insulated from each other and a plurality of second sensing series electrically insulated from each other. The first sensing series are intersected with and electrically insulated from the second sensing series. A plurality of floating electrodes are disposed at the gap between the first sensing series and the second sensing series.

By the design of floating electrodes, the gap between the first sensing series and the second sensing series is reduced and the profile of the first sensing series and the second sensing series is not conscious of by users. However, since the distance between touch-sensing pads of the first electrode series is long and the bridge lines is required to be long enough, the overall resistance of each first electrode series increases. Accordingly, resistance-capacitance delay (RC delay) of the first electrode series increases and sensitivity of the first electrode series deteriorates. The same problem also occurs in the second electrode series.

### SUMMARY OF THE INVENTION

The invention provides a touch-sensing panel having superb touch-sensing function.

The present invention provides a touch-sensing panel including a substrate, a plurality of first electrode series, a plurality of second electrode series, and a plurality of first floating patterns. The first electrode series are disposed on the substrate and electrically insulated from each other. Each of the first electrode series includes a plurality of first touch-sensing pads and a plurality of first bridge patterns. The first touch-sensing pads and the first bridge patterns are connected to each other and are arranged alternately. The second electrode series are disposed on the substrate and electrically insulated from each other. The second sensing series are intersected with and electrically insulated from the first sensing series. Each of the second electrode series includes a plurality of second touch-sensing pads and a plurality of second bridge patterns. The second touch-sensing pads and the second bridge patterns are connected to each other and are arranged alternately. The first floating patterns are disposed between the first sensing series and the second sensing series. Each of the first touch-sensing pads includes at least one extending portion. The extending portion is directly connected to the first bridge patterns adjacent thereto. In addition, there is no first floating pattern located between the extending portion and the second electrode series adjacent thereto.

The present invention further provides a touch-sensing display apparatus including a touch-sensing panel and a display panel connected to the touch-sensing panel.

In the touch-sensing display apparatus and the touch-sensing panel of this application, the at least one extending portion is capable of reducing resistance of the first electrode series. Accordingly, signal is transmitted efficiently by the first electrode series and the second electrode series, sensitivity of the touch-sensing panel and the touch-sensing display apparatus is favorable.

In order to make the aforementioned features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A are top views of a touch sensing panel of one embodiment of the present invention.

FIG. 1B illustrates a region 1 of FIG. 1A.

FIG. 2 through FIG. 7, FIG. 9 are respectively top views of touch sensing panels of different embodiments of the present invention.

FIG. 8 schematically illustrates a cross-sectional view of a touch-sensing display apparatus according to one embodiment of the present invention.

FIG. 10A are top views of a touch sensing panel of one embodiment of the present invention.

FIG. 10B illustrates a region 2 of FIG. 10A.

### DETAILED DESCRIPTION OF DISCLOSED EMBODIMENTS

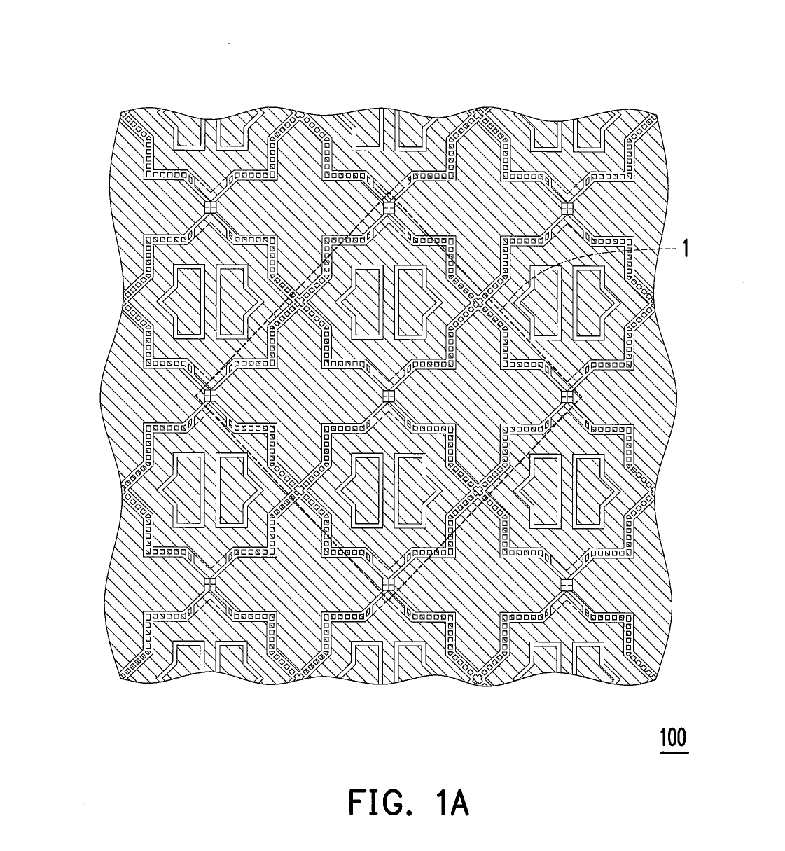

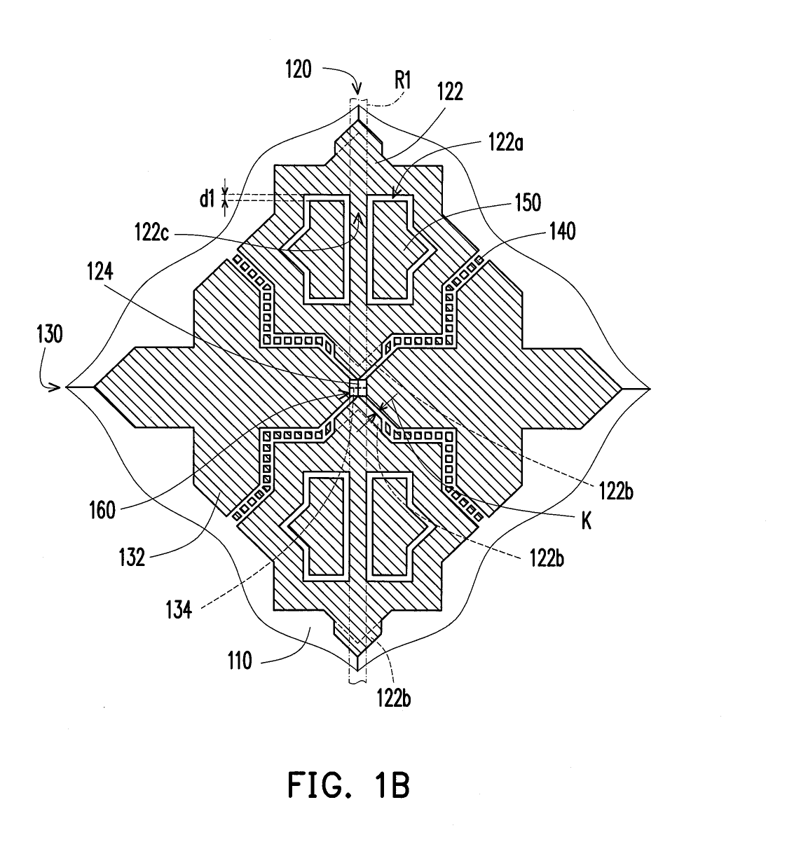

Referring to FIG. 1A and FIG. 1B, the touch-sensing panel 100 of this embodiment includes a substrate 110, a plurality of first electrode series 120 electrically insulated from each other, a plurality of second electrode series 130 electrically insulated from each other, and a plurality of first floating patterns 140 between the first electrode series 120 and the second electrode series 130.

The first electrode series 120, the second electrode series 130 and the first floating patterns 140 are disposed at the same side of the substrate 100. The first floating patterns 140 compensate or reduce the gaps between the first electrode series 120 and the second electrode series 130, and visual uniformity of the touch-sensing panel 100 is enhanced, accordingly.

Each of the first electrode series 120 includes a plurality of first touch-sensing pads 122 and a plurality of first bridge patterns 124, wherein the first touch-sensing pads 122 are electrically connected to each other through the first bridge patterns 124. Each of the second electrode series 130 includes a plurality of second touch-sensing pads 132 and a plurality of second bridge patterns 134, wherein the second touch-sensing pads 132 are electrically connected to each other through the second bridge patterns 134. The first bridge patterns 124 are intersected with the second bridge patterns 134. Furthermore, an insulating layer 160 is at least disposed at an overlapped region of the first bridge patterns 124 and the second bridge patterns 134.

An area of each of the first touch-sensing pads 122 is less than that of the second touch-sensing pads 132. In this way, the first electrode series 120 for reading touch-sensing signal are not interfered by the noise easily, and sensitivity of the touch-sensing panel 100 is favorable accordingly.

In this embodiment, at least one first enclosed opening 122a is formed in each of the first touch-sensing pads 122 so as to reduce the area of the first touch-sensing pads 122. However, the resistance of the first electrode series 120 increases due to the first enclosed opening 122a. It is unfavorable for driving of the touch-sensing panel 100. In this embodiment, each of the first touch-sensing pads 122 has at least one extending portion 122b so as to decrease the resistance of the first electrode series 120. The extending portion 122b is directly connected to the first bridge patterns 124 adjacent thereto. In addition, there is no first floating pattern 140 located between the extending portion 122b and the second electrode series 130 adjacent thereto. The extending portion 122b of the first touch-sensing pads 122 extends toward the intersection of the first bridge patterns 124 and the second bridge patterns 134, so as to decrease the resistance of the first electrode series 120. Accordingly, the problem of excessively high resistance of the first electrode series 120 can be improved and sensitivity of the touch-sensing panel 100 of this embodiment is superb. In addition, the minimum distance K between the extending portion 122b and the second electrode series 130 adjacent thereto is less than or substantially equal to 50 micrometers, such that the gap between the extending portion 122b and the second electrode series 130 is not conscious of by users.

When the first electrode series 120 are designed for reading and transmitting touch-sensing signal, the second electrode series 130 are designed for transmitting driving signal, for example. The above-mentioned driving signal is, for example, a driving pulse. When the driving pulse is applied to the second electrode series 130, the second electrode series 130 may be grounded or electrically connected to a fixed voltage so as to provide shielding function. In this way, when touch-sensing signal is read or transmitted by the first electrode series 120, the first electrode series 120 are not interfered by the noise easily and sensitivity of the touch-sensing panel 100 is better.

Moreover, in this embodiment, at least one second floating pattern 150 is disposed in the first enclosed opening 122a so to further enhance visual uniformity of the touch-sensing panel 100. Preferably, the gap d1 between the second floating pattern 150 and the first touch-sensing pads 122 is less than 50 micrometers, but the gap d1 is not limited in this invention.

Since sensitivity of the touch-sensing panel 100 and resistance of the first electrode series 120 are trade-off in design, both of the touch-sensing panel 100 and resistance of the first electrode series 120 should be considered when determining the position of the first enclosed opening 122a. It is note that the quantity, shape and position of the first enclosed opening 122a are not limited in this invention. Certainly, the quantity and shapes of the second floating patters 150 disposed in the first enclosed opening 122a are not limited in this invention. The quantity and shapes of the second floating patters 150 should be determined by actual design requirements.

In this embodiment, the substrate 110 is a cover glass. The substrate 100 is a transparent plate having decoration layer formed thereon. The substrate 100 may be an active device array substrate, a color filter substrate, a polarizer or a light guide plate. The first electrode series 120 and the second electrode series 130 can be added on to a display panel or formed in a display panel. The substrate 110 can be a rigid substrate (e.g. a glass substrate, a quartz substrate, or an polymer substrate) or a flexible substrate (e.g. a plastic substrate or other appropriate substrate).

In this embodiment, the first bridge pattern 124, the first touch-sensing pads 122, the second bridge pattern 134, the second touch-sensing pads 132 and the first floating pattern 140 are made of alloys, nitrides of metallic materials, oxides of metallic materials, stacked layers of metallic materials and other conductive materials, other oxides, or the combinations thereof. The material of the insulating layer 160 is inorganic materials, organic materials or the combinations thereof, for example. However, the material of the insulating layer 160 is not limited in this invention.

Another embodiments of this invention are illustrated as follows. Referring to FIG. 1A and FIG. 1B, the shapes of the first touch-sensing pads 122, the second touch-sensing pads 132, the first enclosed opening 122a, the first floating patterns 140 and the second floating patterns 150 is polygonal. Specifically, the shape of each of the first floating patterns 140 is rectangular or rhombic, and the second touch-sensing pads 132 is similar to cross. Certainly, the shapes of first touch-sensing pads 122, the second touch-sensing pads 132, the first enclosed opening 122a, the first floating patterns 140 and the second floating patterns 150 is not limited in this invention. The shapes of the first touch-sensing pads 122, the second touch-sensing pads 132, the first enclosed opening 122a, the first floating patterns 140 and the second floating patterns 150 should be determined by actual design requirements.

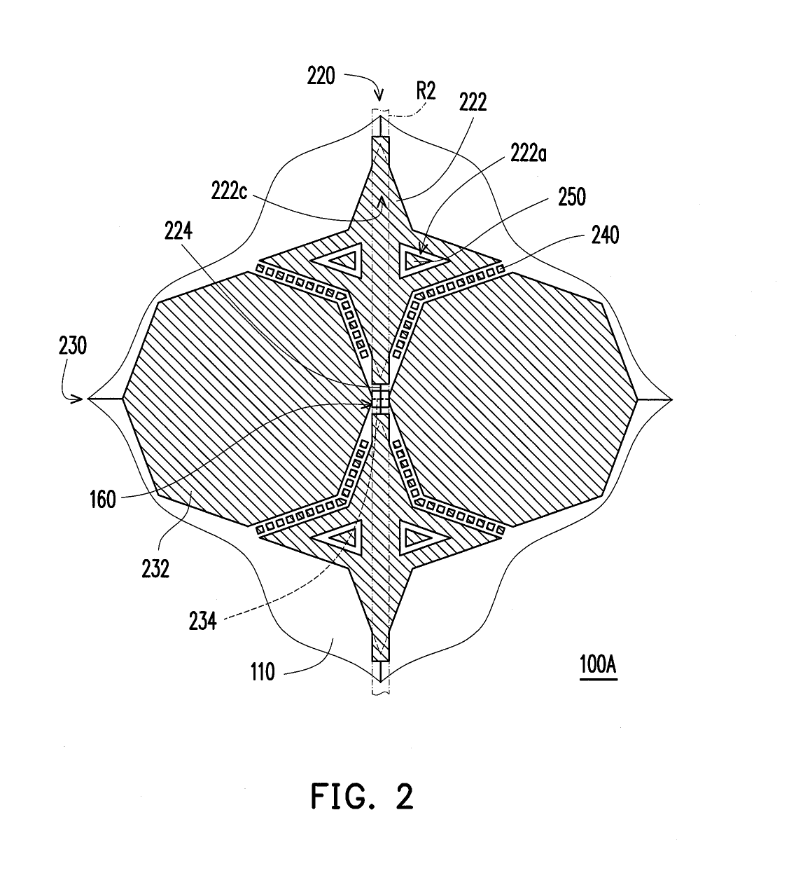

Referring to FIG. 2, the shape of each of the first touch-sensing pads 222 is star, the shape of each of the second touch-sensing pads 232 is octagonal, the shapes of the first enclosed openings 222a and the second floating patterns 250 are triangular, and the shape of each of the first floating patterns 240 is polygonal.

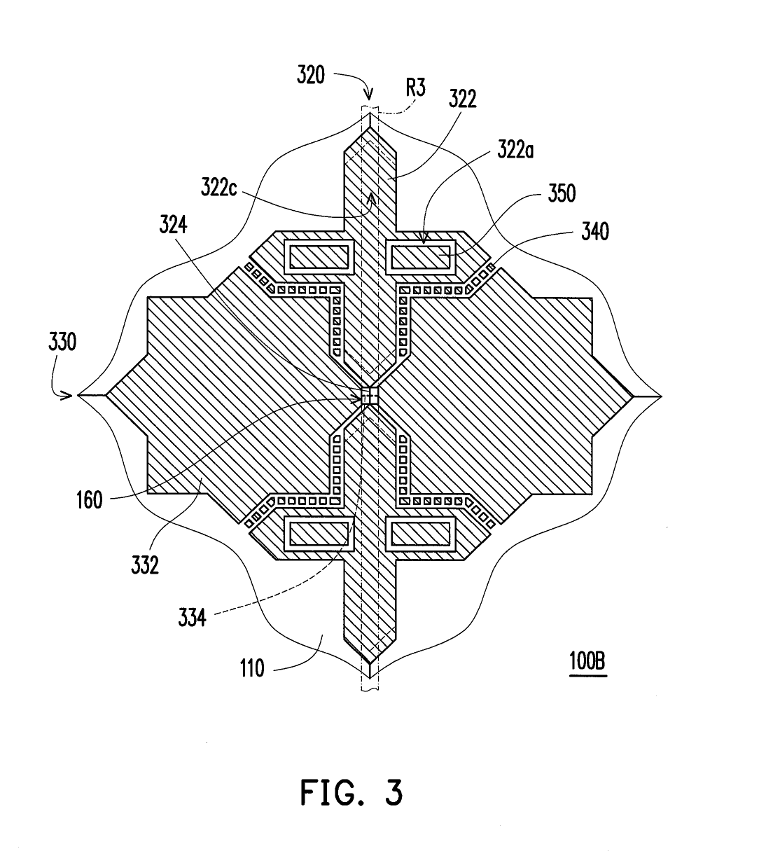

Referring to FIG. 3, the shape of each of the first touch-sensing pads 322 is similar to cross, the shape of each of the second touch-sensing pads 332 is polygonal. The shapes of the first enclosed opening 322a, the first floating patterns 340 and the second floating patterns 350 are polygonal, circular, elliptic, any geometric, irregular or the combinations thereof.

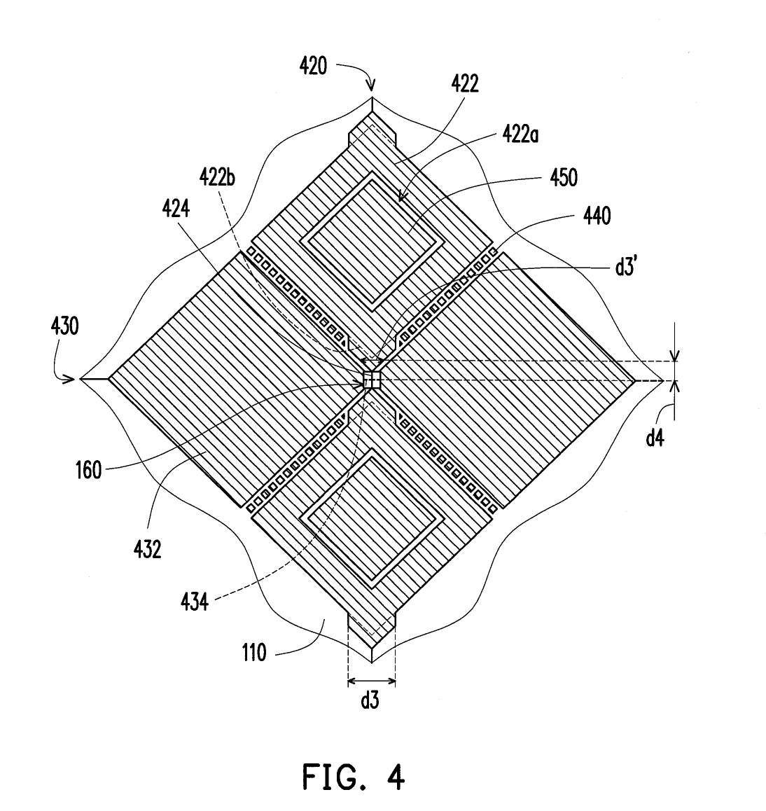

Referring to FIG. 4, the shape of each of the first touch-sensing pads 422 is hollow rhombic, the shapes of the second touch-sensing pads 432, the first enclosed opening 422a and the first floating patterns 440 are polygonal, the shape of each of the second floating patterns 450 is rhombic. Certainly, the shapes of first touch-sensing pads 422, the second touch-sensing pads 432, the first enclosed opening 422a, the first floating patterns 440 and the second floating patterns 450 are not limited in this invention. The shapes of the first touch-sensing pads 422, the second touch-sensing pads 432, the first enclosed opening 422a, the first floating patterns 440 and the second floating patterns 450 should be determined by actual design requirements. In this embodiment, the extending portion 422b has a maximum width d3 greater than or substantially equal to 400 micrometers, for example. It is noted that the width of the extending portion 422b may properly shrink in the vicinity of the intersection of the first electrode series 420 and the second electrode series 430. When the width of the extending portion 422b shrinks to d3′ that is about 300 micrometers, the minimum distance d4 between the extending portion 422b having a width of d3′ (i.e. 300 micrometers) and the intersection of the first bridge pattern 424 and the second bridge pattern 434 is less than or substantially equal to 500 micrometers.

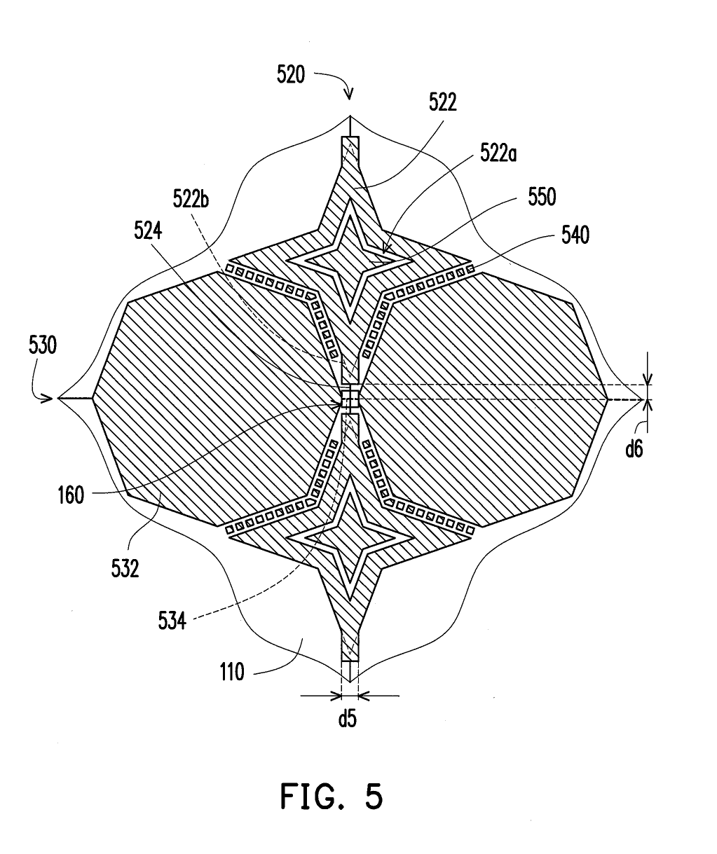

Referring to FIG. 5, the shapes of the first touch-sensing pads 522, the first enclosed opening 522a and the second floating patterns 550 are similar to star. The shape of each of the second touch-sensing pads 532 is octagonal, and the shape of each of the first floating patterns 540 is rectangular, trapezoid, polygonal or the combinations thereof. In this embodiment, the width of the extending portion 522b is d5. The width d5 is greater than or substantially equal to 300 micrometers, preferably. It is noted that the minimum distance d6 between the extending portion 522b and the intersection of the first bridge pattern 524 and the second bridge pattern 534 is less than or substantially equal to 350 micrometers.

Preferably, the widths d3 and d5 is at least greater than 300 micrometers, and the distances d4 and d6 may be less than 500 micrometers.

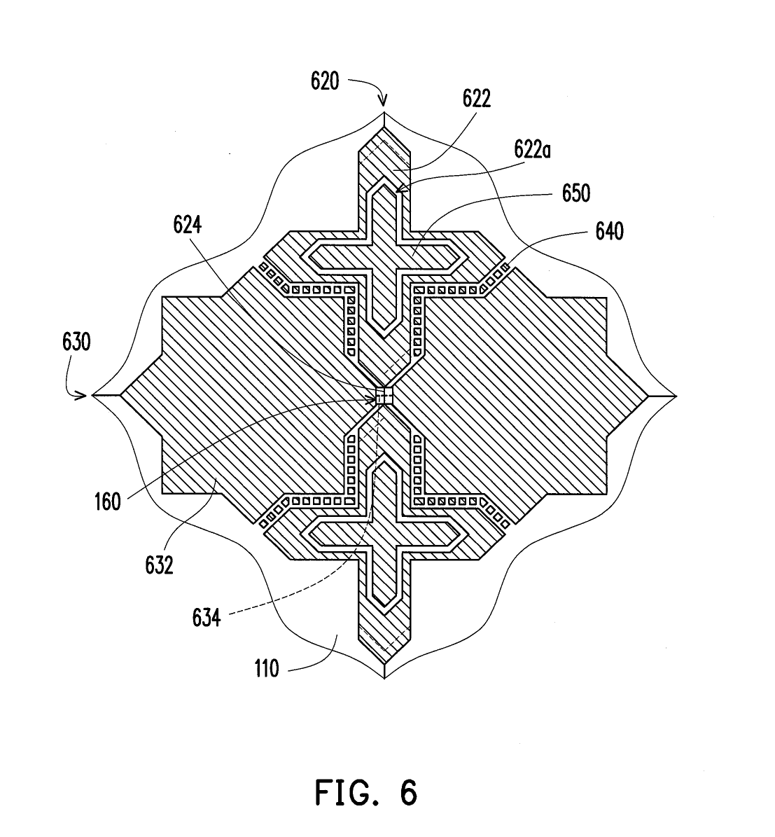

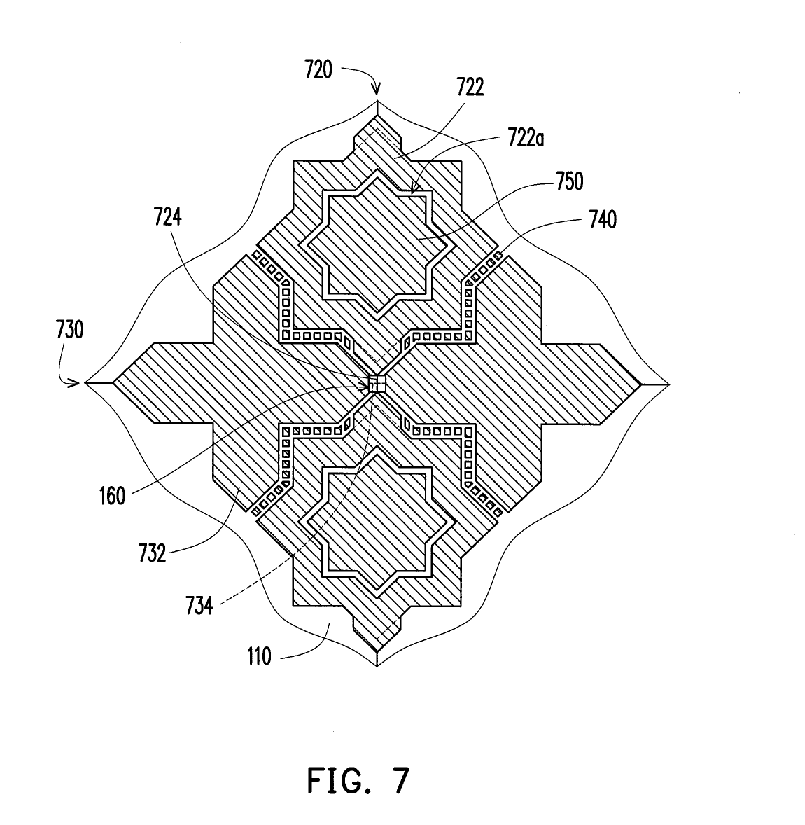

Referring to FIG. 6, the shapes of the first touch-sensing pads 622, the first enclosed opening 622a and the second floating patterns 650 are similar to cross. The shape of each of the second touch-sensing pads 632 is polygonal, and the shape of each of the first floating patterns 640 is rectangular, polygonal, hexagonal or the combinations thereof. Referring to FIG. 7, the shapes of the first touch-sensing pads 722, the first enclosed opening 722a and the second floating patterns 750 are polygonal. The shape of each of the second touch-sensing pads 732 is similar to star, and the shape of each of the first floating patterns 740 is rectangular, rhombic, polygonal or the combinations thereof. Certainly, the shapes of first touch-sensing pads 422, the second touch-sensing pads 432, the first enclosed opening 422a, the first floating patterns 440 and the second floating patterns 450 are not limited in this invention. The shapes of the first touch-sensing pads 422, the second touch-sensing pads 432, the first enclosed opening 422a, the first floating patterns 440 and the second floating patterns 450 should be determined by actual design requirements.

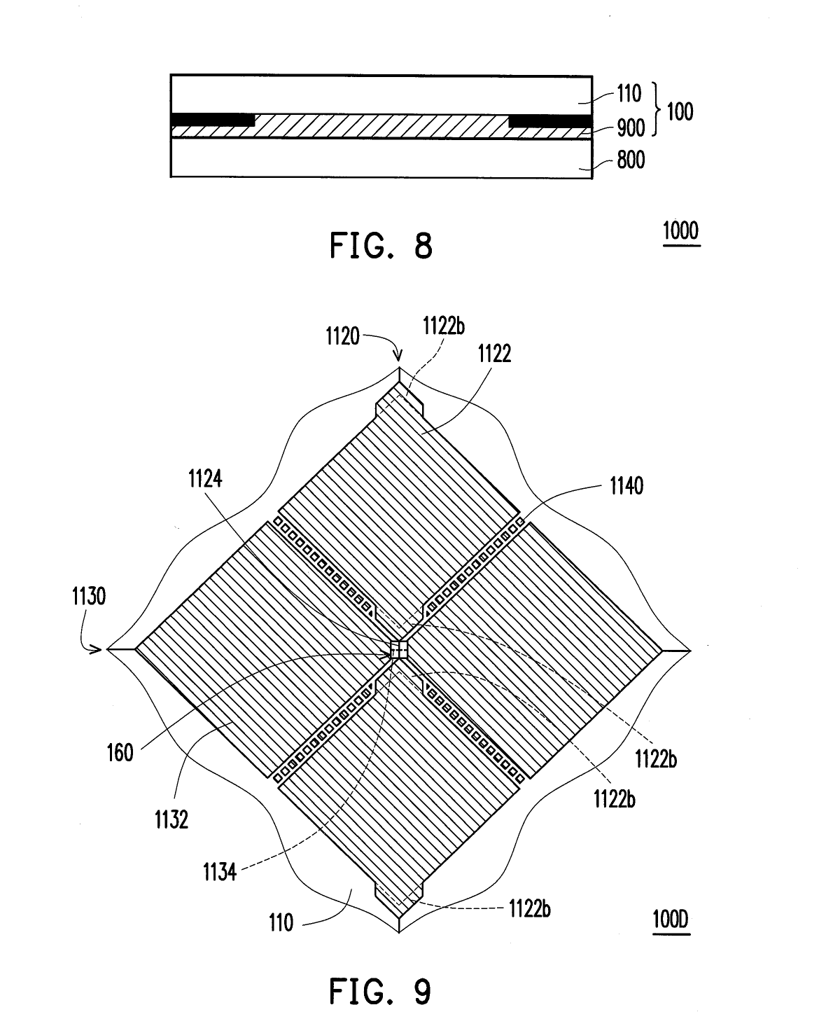

FIG. 8 schematically illustrates a cross-sectional view of a touch-sensing display apparatus according to one embodiment of the present invention. Referring to FIG. 8, the touch display apparatus 1000 of this embodiment includes the above-mentioned touch-sensing panel (e.g. touch-sensing panel 100) and a display panel 800 electrically connected to the touch-sensing panel. In this embodiment, the display panel 800 is, for example, a liquid crystal display panel, an organic electro-luminescent display panel, an electrowetting display panel or an electrophoretic display panel.

FIG. 9 schematically illustrates a top view of a touch-sensing panel according to the second embodiment of the present invention. Referring to FIG. 9, the touch-sensing panel 100D is similar to the touch-sensing panel 420 shown in FIG. 4, and therefore, the same components are labeled by the same reference numbers. Referring to FIG. 9, in the touch-sensing panel 100D, the shapes of the first touch-sensing pad 1122. the second touch-sensing pads 1132 and parts of the first floating patterns 1140 are different from those in the first embodiment. In addition, the first touch-sensing pads 1122 have no enclosed opening. In this case, the outer profile of each of the first touch-sensing pads 1122 is smaller than the outer profile of each of the second touch-sensing pads 1132. The extending portions 1122b of the first touch-sensing pads 1122 may reduce the resistance of the first electrode series 1120, and sensitivity of the touch-sensing panel 100D is enhanced accordingly.

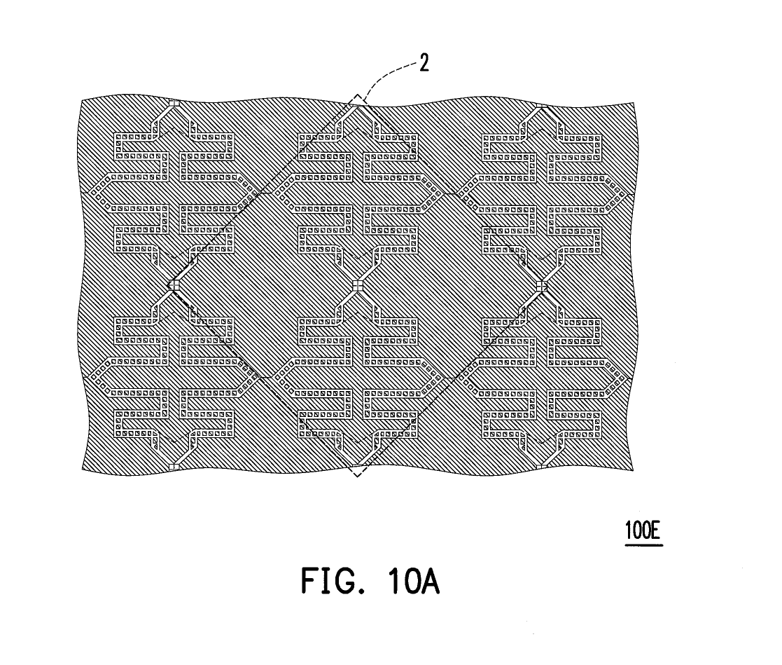

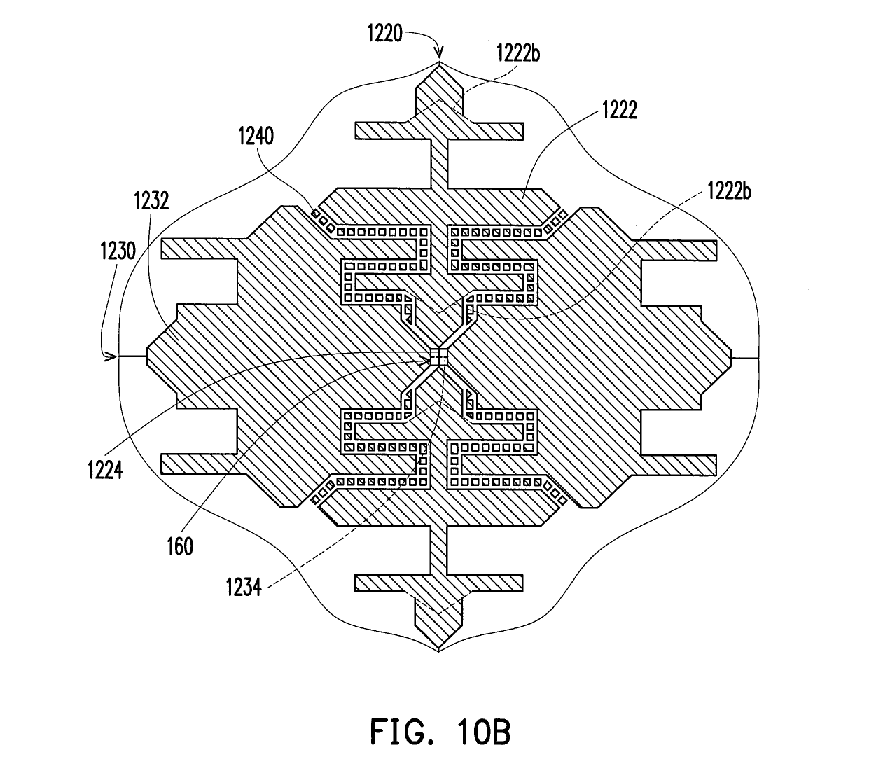

FIG. 10A and FIG. 10B schematically illustrates a top view of a touch-sensing panel according to the third embodiment of the present invention. Referring to FIG. 10A and FIG. 10B, the touch-sensing panel 100E is similar to the touch-sensing panel 100 shown in FIG. 1A and FIG. 1B, and therefore, the same components are labeled by the same reference numbers. In the touch-sensing panel 100E, the shapes of the first touch-sensing pad 1222. the second touch-sensing pads 1232 and parts of the first floating patterns 1240 are different from the shapes of the first touch-sensing pad 122. the second touch-sensing pads 132 and parts of the first floating patterns 140 shown in FIG. 1A and FIG. 1B. In addition, the first touch-sensing pads 1222 have no enclosed opening. In the present embodiment, the shapes of the first touch-sensing pad 1222. the second touch-sensing pads 1232 are “ [symbol] ” shaped. Compared with the touch-sensing panel 100 of FIG. 1A and FIG. 1B, the first touch-sensing pads 1222 of this embodiment have no enclosed opening and the resistance thereof can be further reduced. Accordingly, sensitivity of the touch-sensing panel 100E is enhanced.

In the touch-sensing panel and the touch-sensing display apparatus of this application, the area of each first touch-sensing pad is smaller than the area of each second touch-sensing pad, and the extending portion of each first touch-sensing pad is capable of reducing resistance of the first electrode series. Accordingly, signal is transmitted efficiently by the first electrode series, such that sensitivity of the touch-sensing panel and the touch-sensing display apparatus is favorable.

Though the invention has been disclosed above by the embodiments, they are not intended to limit the invention. It will be apparent to one of ordinary skill in the art that modifications and variations to the described embodiments may be made without departing from the spirit and scope of the invention. Therefore, the protecting range of the invention falls in the appended claims.

What is claimed is:

1. A touch-sensing panel, comprising:
a substrate;
a plurality of first electrode series, disposed on the substrate and electrically insulated from each other, each of the first electrode series including a plurality of first touch-sensing pads and a plurality of first bridge patterns, the first touch-sensing pads and the first bridge patterns being arranged alternately, and the first touch-sensing pads being electrically connected to each other through the first bridge patterns;
a plurality of second electrode series, disposed on the substrate and electrically insulated from each other, the second electrode series are interlaced with the first electrode series and are electrically insulated with the first electrode series, each of the second electrode series including a plurality of second touch-sensing pads and a plurality of second bridge patterns, the second touch-sensing pads and the second bridge patterns being arranged alternately, and the second touch-sensing pads being electrically connected to each other through the second bridge patterns; and
a plurality of first floating patterns, disposed between the first sensing series and the second sensing series;
wherein each of the first touch-sensing pads has at least one extending portion, the extending portion is directly connected to the first bridge patterns adjacent thereto, and there is no first floating pattern located between the extending portion and the second electrode series adjacent thereto.

2. The touch-sensing panel of claim 1, wherein an area of each of the first touch-sensing pads is smaller than an area of each of the second touch-sensing pads,

3. The touch-sensing panel of claim 1, wherein a minimum distance between the extending portion and the intersection of the first electrode series and the second electrode series is less than or substantially equal to 500 micrometers.

4. The touch-sensing panel of claim 1, wherein a maximum width of the extending portion is greater than or substantially equal to 300 micrometers.

5. The touch-sensing panel of claim 1, wherein a width of the extending portion shrinks in the vicinity of the intersection of the first electrode series and the second electrode series, the extending portion has a maximum width greater than or substantially equal to 400 micrometers, and when the width of the extending portion shrinks to 300 micrometers, the minimum distance between the extending portion having a width of 300 micrometers and the intersection of the first electrode series and the second electrode series is less than or substantially equal to 500 micrometers.

6. The touch-sensing panel of claim 1, wherein the extending portion has a fixed width greater than or substantially equal to 300 micrometers, and a minimum distance between the extending portion and the intersection of the first electrode series and the second electrode series is less than or substantially equal to 350 micrometers.

7. The touch-sensing panel of claim 1, wherein a minimum distance between the extending portion and the second electrode series adjacent thereto is less than or substantially equal to 50 micrometers.

8. The touch-sensing panel of claim 1, wherein each of the first touch-sensing pads has at least one first enclosed opening.

9. The touch-sensing panel of claim 8, further comprising a plurality of second floating patterns, wherein each of the second floating patterns is disposed in one of the first enclosed openings respectively.

10. The touch-sensing panel of claim 9, wherein the first touch-sensing pads, the second touch-sensing pads, the first enclosed openings, the first floating patterns and the second floating patterns are coplanar and located over the substrate.

11. The touch-sensing panel of claim 1, wherein shapes of the first touch-sensing pads, the second touch-sensing pads, the first floating patterns and the second floating patterns are polygonal, circular, elliptic or combinations thereof

12. The touch-sensing panel of claim 1, wherein the first substrate is a cover, a glass substrate, a plastic substrate, a polarizer or a light guide plate.

13. A touch-sensing display apparatus, comprising:
a touch-sensing panel, comprising:
a substrate;
a plurality of first electrode series, disposed on the substrate and electrically insulated from each other, each of the first electrode series including a plurality of first touch-sensing pads and a plurality of first bridge patterns, the first touch-sensing pads and the first bridge patterns being arranged alternately, and the first touch-sensing pads being electrically connected to each other through the first bridge patterns;
a plurality of second electrode series, disposed on the substrate and electrically insulated from each other, the second electrode series are interlaced with the first electrode series and are electrically insulated with the first electrode series, each of the second electrode series including a plurality of second touch-sensing pads and a plurality of second bridge patterns, the second touch-sensing pads and the second bridge patterns being arranged alternately, and the second touch-sensing pads being electrically connected to each other through the second bridge patterns; and
a plurality of first floating patterns, disposed between the first sensing series and the second sensing series;
wherein an area of each of the first touch-sensing pads is smaller than an area of each of the second touch-sensing pads, each of the first touch-sensing pads has at least one extending portion, the extending portion is directly connected to the first bridge patterns adjacent thereto, and there is no first floating pattern located between the extending portion and the second electrode series adjacent thereto; and
a display panel, electrically connected to the touch panel.

14. The touch-sensing display apparatus of claim 13, wherein the display panel comprises a liquid crystal display panel, an organic electro-luminescent display panel, an electrowetting display panel or an electrophoretic display panel.
